(19) United States
(12) Patent Application Publication
(10) Pub. No.: US 2009/0183101 A1
(43) Pub. Date: Jul. 16, 2009

(54) Method, Apparatus and Program Storage Device for Providing a Gauge for Displaying Data that Includes Historical-Based Data

(75) Inventors: Thomas Stanton Brugler, Fuquay-Varina, NC (US); Todd Michael Eischeid, Cary, NC (US); Mark E. Molander, Cary, NC (US); Kerry A. Ortega, Raleigh, NC (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/972,524

(22) Filed: Jan. 10, 2008

(51) Int. Cl. G06F 3/048

(52) U.S. Cl. 715/771

(57) ABSTRACT

A method, apparatus and program storage device for providing a gauge for displaying data that includes historical-based data. The plurality of different viewing modes provides different views to past data. A data display element is configured to include a dynamic display component. The data display element is used to display data that is current data and data that is based upon historical data. A plurality of different viewing modes for presenting the dynamic display component may be used.

### BACKGROUND

1. Fields of the Embodiments of the Invention

This invention relates in general to the display of data, and more particularly to a method, apparatus and program storage device for providing a gauge for displaying data that includes historical-based data.

2. Description of Related Art

In the computer field, it is common to store data in a database system and to retrieve such data using a computer system. It is also common to display data in a variety of ways, each of which is suited for displaying a particular type or quantity of data. Many options are available for presenting data. To communicate data effectively to users, designers need to understand the tasks in which readers engage when they look at a graphical display of data. Moreover, there are various factors in making a decision about how to present data. The first factor concerns the type of data being presented.

Several different types of gauges have been used to display an attribute's current value. For example, an attributes current value may be displayed against a range of values (e.g., speedometer, thermometers, and sliding gauges). Though these gauges do a good job at showing the current value, they fail to show data based upon historical data, such as trends or rate of acceleration. A database may be provided to allow a user to retrieve past or historical data. For example, if an operator comes in the morning and looks at a gauge, he/she can only tell the current value, and has no idea what has occurred over the night. The user can opt to change the type of display he/she is looking at. For example, the operator could switch to a bar chart; however, this involves the user changing out the current gauge.

It can be seen then that there is a need for a method, apparatus and program storage device for providing a gauge for displaying data that includes historical-based data.

### SUMMARY OF THE EMBODIMENTS OF THE PRESENT INVENTION

To overcome the limitations in the prior art described above, and to overcome other limitations that will become apparent upon reading and understanding the present specification, embodiments of the present invention include a method, apparatus and program storage device for providing a gauge for displaying data that includes historical-based data.

Embodiments of the present invention include a data display element that is configured to include a dynamic display component. The data display element is used to display data that is current data and data that is based upon historical data. Data based on the historical data is communicated to a user based on the dynamic display component. When a user wants to display data, an instrument gauge in a graphical user interface is used to present the data display element. Different embodiments of the present invention may present the data based on historical values using a plurality of different viewing modes. All viewing modes allow the user to keep their attention on the gauge, without changing the display to another format to display the data that is based on historical data.

In one embodiment of the invention, a data display element is presented. The data display element includes a visual representation of data and a dynamic display component, the dynamic display component being based on historical data. The dynamic display component represents a change derived form the historical data.

In another embodiment of the present invention, a program storage device readable by a computer system and executable by the computer system to perform operations for providing a gauge for displaying data that includes historical-based data. The operations include providing historical data to a user for display using a data display element, configuring a dynamic display component of the data display element and displaying the data display element including the dynamic display component.

In another embodiment of the present invention, a method for displaying data that includes historical-based data is provided. The method includes providing historical data to a user for display using a data display element, configuring a dynamic display component of the data display element and displaying the data display element including the dynamic display component.

These and various other advantages and features of novelty which characterize the embodiments of the present invention are pointed out with particularity in the claims annexed hereto and form a part hereof. However, for a better understanding of the embodiments of the present invention, their advantages, and the objects obtained by their use, reference should be made to the drawings which form a further part hereof, and to accompanying descriptive matter, in which there are illustrated and described specific embodiments of the present invention.

### BRIEF DESCRIPTION OF THE DRAWINGS

Referring now to the drawings in which like reference numbers represent corresponding parts throughout:

FIG. 1 illustrates a data display element using a vector arrow for presenting a dynamic display component to convey historical-based data according to an embodiment of the present invention;

FIG. 2 illustrates data display elements using dots for presenting a dynamic display component to convey historical-based data according to an embodiment of the present invention;

FIG. 3 illustrates a data display element using a playback feature for presenting a dynamic display component to convey historical-based data according to an embodiment of the present invention;

FIG. 4 illustrates data display elements using dots and an assigned time coordinate for presenting a dynamic display component to convey historical-based data according to an embodiment of the present invention;

FIG. 5 is a flow chart of a method for providing a gauge for displaying data that includes historical-based data; and

FIG. 6 illustrates a system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the embodiments of the present invention.

Embodiments of the present invention provide a method, apparatus and program storage device for providing a gauge for displaying data that includes historical-based data. A data display element is configured to include a dynamic display component. The data display element is used to display data that is current data and data that is based upon historical data. Data based on the historical data is communicated to a user based on the dynamic display component. When a user wants to display data, an instrument gauge in a graphical user interface is used to present the data display element. Different embodiments of the present invention may present the data based on historical values using a plurality of different viewing modes. All viewing modes allow the user to keep their attention on the gauge, without changing the display to another format to display the data that is based on historical data.

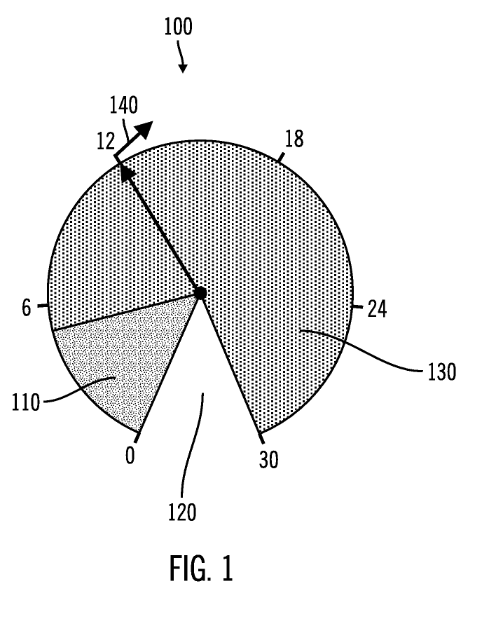

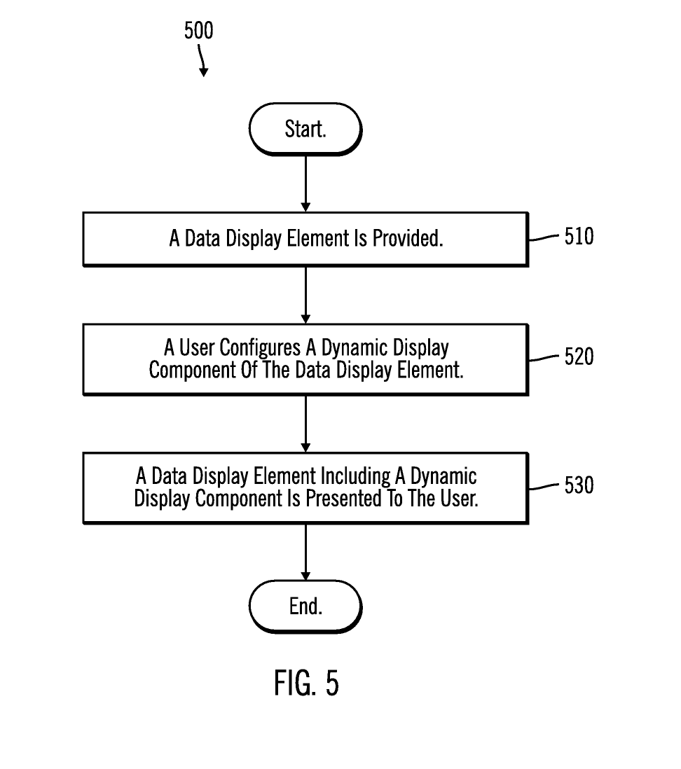

FIG. 1 illustrates a data display element 100 using a vector arrow for presenting a dynamic display component to convey historical-based data according to an embodiment of the present invention. In FIG. 1, the data display element present a graphical representation of data using pie slices 110, 120, 130. In FIG. 1, data based on the historical data is communicated to a user based on the dynamic display component 140. For example, in FIG. 1, a dynamic display component may include a vector arrow 140 that is displayed tangentially from the indicator on the gauge. The vector arrow 140 indicates at least two pieces of information. The vector arrow 140 indicates the direction of change as well as rate of change. For example, increasing values may be conveyed when the vector arrow 140 points to the right (as shown in FIG. 5). Decreasing values may be conveyed when the vector arrow points to the left. The rate of change may be conveyed to the user by changing the width or length of the vector arrow 140.

In addition, the dynamic display component 140 may be configured to represent a default time period that governs the elapsed time-period of interest. Alternatively, the dynamic display component 140 may be illustrated using a time period that is selected by the user.

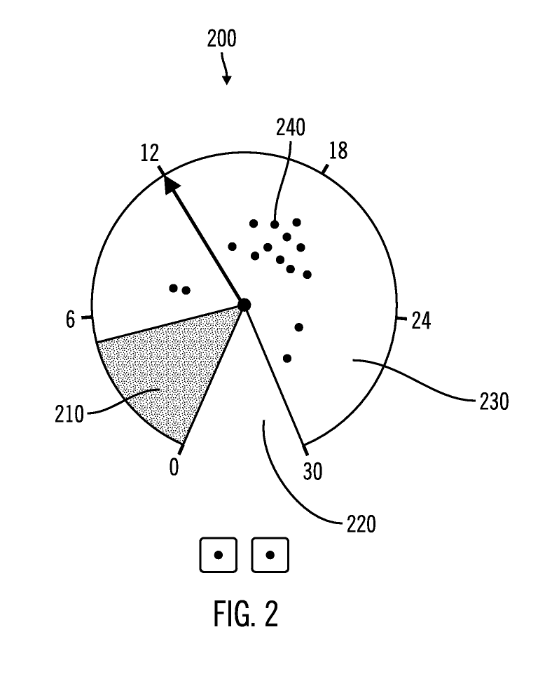

FIG. 2 illustrates data display elements 200 using dots for presenting a dynamic display component to convey historical-based data according to an embodiment of the present invention. In FIG. 2, the data display element present a graphical representation of data using pie slices 210, 220, 230. In FIG. 2, the dynamic display component for conveying the historical-based data is presented using dots 240. For example, the dynamic display component 240 for conveying the historical-based data may be configured so that each dot indicates the gauge's level at a snap shot in time. Accordingly, FIG. 2 illustrates a data display element 200 wherein each of the dots 240 represent the gauge's level at a particular snap shot in time over a predetermined period of time.

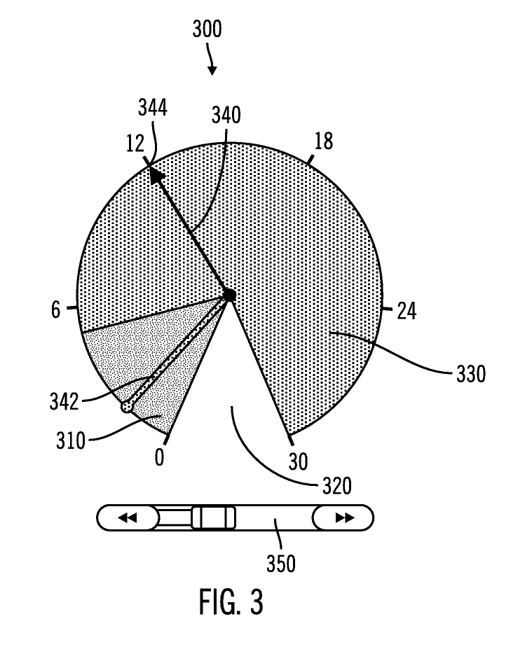

FIG. 3 illustrates a data display element 300 using a playback feature for presenting a dynamic display component to convey historical-based data according to an embodiment of the present invention. In FIG. 3, the data display element present a graphical representation of data using pie slices 310, 320, 330. In FIG. 3, the dynamic display component for conveying the historical-based data is presented using a playback feature. FIG. 3 illustrates a starting position 342 of the dynamic display component 340 and the point 344 where the dynamic display of the historical-based data ends. A playback control bar 350 is also provided to control the playback of the dynamic display component 340.

The dynamic display component 340 may thus be configured to allow the user to play back a historical period, i.e., from point 342 to point 344, over a predetermined elapsed time. For example, the end-user could configure the dynamic display component 340 to play back the last 8 hours, compressed over a 2 minute playback period. The dynamic display component 340 may be configured by the user to define the historical period. The dynamic display component 340 may also be configured by the user to set the conveyance period, i.e., the time required for the playback of the historical period. Not only could the play-back feature provided by the dynamic display component 340 be applied to a single gauge, all the gauges being displayed may include a dynamic display component 340 using the play-back bar 350.

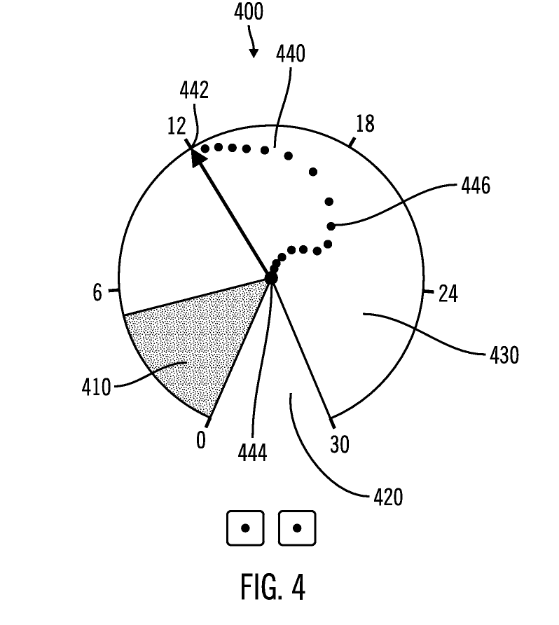

FIG. 4 illustrates a data display element 400 using a time coordinate that is assigned to the distance from the center of the gauge according to an embodiment of the present invention. In FIG. 4, the data display element present a graphical representation of data using pie slices 410, 420, 430. The outer perimeter 442 may be set to T₀ (current time), and the center 444 of the gauge could be Tₙ (full length of time shown in the graph). Thus, at ½ radius 446, the time would be ½n, or half the time the gauge shows. If the full length of historical time the gauge shows is 60 minutes, i.e., from point 442 to point 444, the half way point 446 between center and perimeter of gauge would be 30 minutes ago, and perimeter 0 minutes ago. This would allow user to quickly see trends on the same gauge.

However, those skilled in the art will recognize that the time frame does not have to be linear, but instead may be logarithmic, exponential, etc. Nevertheless, in FIG. 4, the dynamic display component of the data display element illustrates a trend that is decreasing from a recent spike in low 20 s, and currently is 12 but still decreasing:

While four embodiments are described herein, those skilled in the art will recognize that embodiments of the present invention are not meant to be limited to only the embodiments shown above. For example, data may be displayed using bar charts, line graphs or any other graphical data representation technique. Further, embodiments of the dynamic display component is not meant to be limited to vector arrows, dots or playback methods. For example, dynamic display components may include dynamically changing the area of pie slices in a pie chart, radiating fill-ins based on changes in data. Moreover, the dynamic display component may present a snapshot representing the dynamic qualities of data being presented, or the dynamic display component may present actively changing data. For example, the dynamic display component may display real-time updates to historical-based data. The dynamic display component for displaying historical-based data is configured to allow the operator to more easily see relationships between attributes, versus static gauges. In addition, more than one gauge can be displayed to the operator simultaneously.

FIG. 5 is a flow chart 500 of a method for providing a gauge for displaying data that includes historical-based data. In FIG. 5, a data display element is provided 510. A user configures a dynamic display component of the data display element 520. A data display element including a dynamic display component is presented to the user 530.

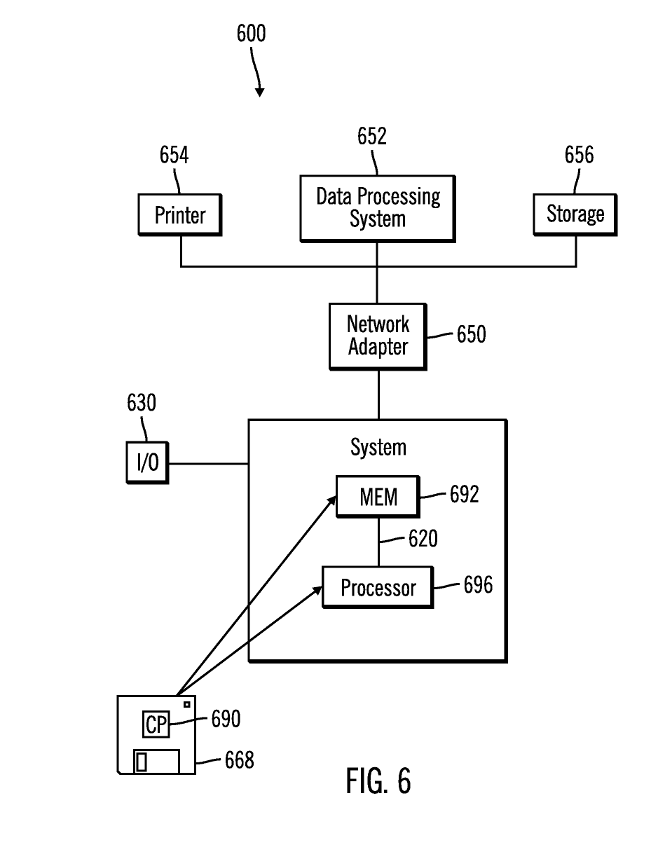

FIG. 6 illustrates a system 600 according to an embodiment of the present invention. Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 690 accessible from a computer-usable or computer-readable medium 668 providing program code for use by or in connection with a computer or any instruction execution system.

For the purposes of this description, a computer-usable or computer readable medium 668 can be any apparatus that can contain, store, communicate, propagate, or transport the program for use by or in connection with the instruction execution system, apparatus, or device. The medium 668 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A system suitable for storing and/or executing program code will include at least one processor 696 coupled directly or indirectly to memory elements 692 through a system bus 620. The memory elements 692 can include local memory employed during actual execution of the program code, bulk storage, and cache memories which provide temporary storage of at least some program code in order to reduce the number of times code must be retrieved from bulk storage during execution.

Input/output or I/O devices 640 (including but not limited to keyboards, displays, pointing devices, etc.) can be coupled to the system either directly to the system or through intervening I/O controllers.

Network adapters 650 may also be coupled to the system to enable the system to become coupled to other data processing systems 652, remote printers 654 or storage devices 656 through intervening private or public networks 660. Modems, cable modem and Ethernet cards are just a few of the currently available types of network adapters.

Accordingly, the computer program 690 comprise instructions which, when read and executed by the system 600 of FIG. 6, causes the system 600 to perform the steps necessary to execute the steps or elements of the present invention

Accordingly, embodiments of the present invention allow a user to easily access historical data without switching gauge types. The plurality of different viewing modes provide different views to past data. The advantage of each view is that the user can keep her/his attention on gauge without changing out the display. Thus, a data display element is configured to include a dynamic display component. The data display element is used to display data that is current data and data that is based upon historical data. Data based on the historical data is communicated to a user based on the dynamic display component. When a user wants to display data, an instrument gauge in a graphical user interface is used to present the data display element. Different embodiments of the present invention may present the data based on historical values using a plurality of different viewing modes. All viewing modes allow the user to keep their attention on the gauge, without changing the display to another format to display the data that is based on historical data.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A data display element, comprising:
a visual representation of data; and
a dynamic display component, the dynamic display component being based on historical data. wherein the dynamic display component represents a change derived form the historical data.

2. The data display element of claim 1, wherein the change derived form the historical data conveys a rate of change.

3. The data display element of claim 1, wherein the dynamic display component comprises an arrow vector.

4. The data display element of claim 3, wherein the arrow vector includes a direction and a magnitude, wherein the direction and the magnitude represent a direction of change in data and a rate of change in the data.

5. The data display element of claim 3, wherein the arrow vector is configured to represent a default time period that governs the elapsed time-period of interest.

6. The data display element of claim 3, wherein the arrow vector is configured to represent a time period that is selected by the user.

7. The data display element of claim 1, wherein the dynamic display component comprises a plurality of dots, wherein each of the plurality of dots indicates a gauge level at a snap shot in time, the plurality of dots representing a predetermined period of time.

8. The data display element of claim 1, wherein the dynamic display component comprises a time period, wherein the time period is defined by an outer perimeter set to the current time and the center of the data display element gauge representing the full length of time covered by the data display element.

9. The data display element of claim 1, wherein the dynamic display component comprises a playback feature for presenting the historical data as the historical data changes over a predetermined period of time.

10. The data display element of claim 9, wherein the playback feature includes a playback control bar for controlling the playback of the dynamic display component.

11. The data display element of claim 9, wherein the playback feature may be configured to shown changes in data over a first selected period of time and displayed in a second selected period of time.

12. A program storage device readable by a computer system, comprising:
program instructions executable by a computer system to perform operations for providing a gauge for displaying data that includes historical-based data, the operations comprising:
providing historical data to a user for display using a data display element;
configuring a dynamic display component of the data display element; and
displaying the data display element including the dynamic display component.

13. The program storage device of claim 12, wherein the configuring a dynamic display component of the data display element further comprises configuring the dynamic display component to conveys a rate of change.

14. The program storage device of claim 12, wherein the configuring a dynamic display component of the data display element further comprises configuring the dynamic display component to display change in historical data using an arrow vector.

15. The program storage device of claim 14, wherein the configuring the dynamic display component to display change in historical data using an arrow vector further comprises configuring the arrow vector to includes a direction of change in data and a rate of change in the data over a time period that governs the elapsed time-period of interest.

16. The program storage device of claim 12, wherein the configuring a dynamic display component of the data display element further comprises configuring the dynamic display component to display change in historical data using a plurality of dots, wherein each of the plurality of dots indicates a gauge level at a snap shot in time, and wherein the plurality of dots represent a predetermined period of time.

17. The program storage device of claim 12, wherein the configuring a dynamic display component of the data display element further comprises configuring the dynamic display component to display change in historical data using a play-back feature for presenting the historical data as the historical data changes over a predetermined period of time.

18. The program storage device of claim 17, wherein the configuring the dynamic display component to display change in historical data using a play-back feature further comprises providing a playback control bar for controlling the playback of the dynamic display component.

19. The program storage device of claim 17, wherein the configuring a dynamic display component of the data display element further comprises configuring the playback feature to show changes in data over a first selected period of time and displayed in a second selected period of time.

20. A method for displaying data that includes historical-based data, comprising:
providing historical data to a user for display using a data display element;
configuring a dynamic display component of the data display element; and
displaying the data display element including the dynamic display component.
